(19) United States
(12) Patent Application Publication
(10) Pub. No.: US 2026/0112636 A1
(43) Pub. Date: Apr. 23, 2026

(54) FUNCTIONALIZED PRE-CROSSLINKED HYDROGENATED NITRILE RUBBERS AS AQUEOUS BASED CATHODE BINDERS FOR LI-ION BATTERY APPLICATIONS

(71) Applicant: ARLANXEO DEUTSCHLAND GMBH, Dormagen (DE)

(72) Inventors: Björn LOGES, Dormagen (DE); Arlavinda REZQITA, Dormagen (DE); Niklas STRUCH, Dormagen (DE); Sven BRANDAU, Dormagen (DE)

(21) Appl. No.: 19/475,833

(22) PCT Filed: Apr. 11, 2024
(86) PCT No.: PCT/EP2024/059799

§ 371 Date: Oct. 16, 2025

(30) Foreign Application Priority Data
Apr. 20, 2023 (EP) 23169002.5

(51) Int. Cl. H01M 4/62; C08F 8/04; H01M 4/136

(52) U.S. Cl. CPC H01M 4/622; C08F 8/04; H01M 4/136; C08F 2800/20; C08F 2810/20

(57) ABSTRACT

The invention relates to a functionalized and pre-crosslinked hydrogenated nitrile rubber as a binder in a cathode of a battery cell, to a cathode of a battery cell comprising said polymer, and to a composition comprising said polymer and an organic solvent.

### FIELD OF INVENTION

The invention relates to a functionalized, hydrogenated and pre-crosslinked polymer [i.e., (H)NBR] as a binder in a cathode of a battery cell, to a cathode of a battery cell comprising said polymer, and to a composition comprising said polymer and an organic solvent.

### BACKGROUND OF INVENTION

A rechargeable battery (also known as a storage battery, a secondary cell or an accumulator) is a type of electrical battery which can be charged, discharged and recharged many times. The battery cell comprises electrodes (anode and cathode), an electrolyte and a separator. Within the electrodes, a polymeric binder typically holds active material and conductive material. The binder needs to be flexible and insoluble in the electrolyte. It should provide good adherence to a current collector and have chemical as well as electrochemical stability. Further, it should be applicable to the electrodes in an easy manner.

Polyvinylidene fluoride polymer (PVDF) is frequently used as a binder in the solvent-based production of cathodes using NMP as solvent. Partly it can be used as dispersed PVDF in aqueous cathode production to avoid the use of toxic NMP. However, PVDF has several drawbacks because the fluorine causes corrosion within the rechargeable battery and is inherently unsafe. As the fluorine can form hydrogen fluoride, handling of PVDF requires precautionary safety measures. PVDF has a relatively high density and thus increases the weight of the rechargeable battery.

References US 2016/0079007 A1, US 2013/0171521 A1, US 2013/0017402 A1, WO 2004/045007 A2 and JP 2014 203804 A disclose certain water-based binders, such as SBR latex and non-crosslinked HNBR latex.

Therefore, in the context of binders, the prior art essentially discloses (i) polyvinylidene fluoride polymer (PVDF), (ii) SBR latex which has residual double bonds and limited stability when used as cathode binder for LFP, or (iii) non-crosslinked HNBR latex for LiCoO₂ (LCO) and LiNi₂O (LNO). While the SBR latex shows limited electrochemical stability, non-pre-crosslinked polymers lack stability in electrolytes resulting in capacity fading.

In view of the deficiencies of the known binders, there is a need for polymers that can be used as stable cathode binders and that have advantages compared to the polymers of the prior art.

It is therefore an object of the invention to provide binders, battery cells and cathodes thereof that have advantages compared to the prior art, especially with regard to safety, environmental issues, electrochemical stability and high capacity retention.

### SUMMARY OF INVENTION

This object has been achieved by the subject-matter of the patent claims.

Pre-crosslinked and functionalized HNBR latices with different functional groups have been developed and tested as aqueous based polymer binders for LiFePO₄ (LFP) cathodes.

In a first aspect, the invention relates to a pre-crosslinked and functionalized HNBR and its use as a binder in a cathode of a battery cell, wherein the pre-crosslinked and functionalized HNBR comprises or essentially consists of monomer units derived from 1,3-butadiene, acrylonitrile, a functional monomer which is methacrylic acid or hydroxyethyl methacrylate, and a pre-crosslinking monomer which is trimethylolpropane trimethacrylate.

In a second aspect, the invention relates to a cathode of a battery cell comprising a pre-crosslinked and functionalized HNBR which comprises or essentially consists of monomer units derived from 1,3-butadiene, acrylonitrile, a functional monomer which is methacrylic acid or hydroxyethyl methacrylate, and a pre-crosslinking monomer which is trimethylolpropane trimethacrylate.

In a third aspect, the invention relates to a composition for manufacturing a cathode of a battery cell, said composition comprising (i) a pre-crosslinked and functionalized HNBR which comprises or essentially consists of monomer units derived from 1,3-butadiene, acrylonitrile, a functional monomer which is methacrylic acid or hydroxyethyl methacrylate, and a pre-crosslinking monomer which is trimethylolpropane trimethacrylate; and (ii) a solvent.

It has been surprisingly found that due to pre-crosslinking, the functionalized HNBR according to the invention have a high capacity retention which makes them suitable as binders for Li-ion batteries. Due to good electrochemical stability up to 4.5 V vs. Li/Li⁺, they can be applied not only for LFP electrodes, but also for NMC cathodes.

Further, it has been surprisingly found that in comparison to standard SBR binders a higher electrochemical stability is achieved by the pre-crosslinked and functionalized HNBR according to the invention and through their pre-crosslinking a low swelling in electrolytes is enabled.

Still further, it has been surprisingly found that by using pre-crosslinked and functionalized HNBR according to the invention binders can be provided which enable water-based processing for cathode materials resulting in an electrode with good adhesion, excellent flexibility, and stable electrochemical cycling stabilities.

The inventors developed a new stable latex with different monomer combinations, enabled an aqueous hydrogenation and identified the need of the pre-crosslinking, the potential hydrogenation of the polymer and the use of specific monomer combinations to solve the given object. In comparison to standard SBR binders a higher electrochemical stability is achieved and through the pre-crosslinking a high capacity retention is enabled. It is shown that the pre-crosslinked and functionalized HNBR latices can be used as polymer binders e.g. for aqueous-based LFP batteries.

Moreover, the pre-crosslinked and functionalized HNBR provides an at least suitable alternative to the cathode binders of the prior art whilst overcoming the need to use polyvinylidene fluoride (PVDF).

The pre-crosslinked and functionalized HNBR and a cathode binder based on the pre-crosslinked and functionalized HNBR according to the invention may be free of PVDF thereby overcoming safety issues and issues with respect to corrosion during manufacture and use in battery applications.

The pre-crosslinked and functionalized HNBR exhibits at least the same or superior binder properties compared to conventional cathode binders based on PDVF.

The pre-crosslinked and functionalized HNBR has a lower density compared to PDVF and due to its reduced weight is favorable in portable devices or electric vehicles using a rechargeable battery.

When used as a cathode binder, the pre-crosslinked and functionalized HNBR maintains capacity retention after being charged, discharged and recharged.

### DETAILED DESCRIPTION

For a complete understanding of the present invention and the advantages thereof, reference is made to the following detailed description. It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention.

The term “monomer units” preferably means that a structural unit derived from that monomer is incorporated in the polymer backbone which is obtained by polymerizing that monomer. A skilled person recognizes that polymerization changes the monomer structure and such change is expressed by the term “derived from”. Further, as the polymer according to the invention is preferably hydrogenated, such hydrogenation may further change the monomer unit derived from that monomer. In particular, radical polymerization of 1,3-butadiene using suitable catalysts may result in monomer units still having ethylenic unsaturations that upon subsequent hydrogenation are fully or partially saturated.

The term “monomer mixture” preferably means the mixture of 1,3-butadiene, acrylonitrile, methacrylic acid or hydroxyethyl methacrylate, and trimethylolpropane trimethacrylate.

The term “pre-crosslinked” preferably means that crosslinking is performed upon manufacture of the respective polymer. Methods to provide such pre-crosslinking of polymers are provided with the experimental section (see e.g., “Preparation of inventive and comparative polymer latex”).

The production of pre-crosslinked nitrile rubbers is typically effected in the latex state and can be achieved firstly during the polymerization by continuing the polymerization up to high conversions, or performing the copolymerization with crosslinking polyfunctional compounds. It is also possible to prepare pre-crosslinked nitrile rubbers by polymerization in the absence of molecular weight regulators.

The degree of pre-crosslinking can be determined via the gel content. The pre-crosslinked nitrile rubbers according to the invention typically have a gel content of at least 60%, preferably of at least 65% and more preferably of 68% to 100%, especially of 70% to 100%.

Determination of gel content is preferably performed as follows: 250 mg of the nitrile rubber are dissolved in 25 ml of a solvent (ethyl carbonate (EC)/methyl ethyl carbonate (EMC) 3/7)) with stirring at 25° C. for 24 h. The insoluble fraction is removed by ultracentrifugation at 20 000 rpm at 25° C., dried and determined by gravimetry. Gel content is reported in % by weight based on the starting weight.

Fully hydrogenated in view of the pre-crosslinked and functionalized HNBR shall mean an amount of residual double bonds are <1%, to be partially hydrogenated, residual double bonds are <5%.

Preferably, the pre-crosslinked and functionalized HNBR is at least partially, more preferably fully hydrogenated. Preferably, the content of residual C═C double-bonds is at most 5%, more preferably at most 4%, relative to the content of C═C double-bonds before hydrogenation. Hydrogenation is preferably performed under conditions that do not essentially affect acrylonitrile and optionally present methacrylic acid and/or hydroxyethyl methacrylate.

The pre-crosslinked and functionalized HNBR may comprise additional monomer units to those derived from 1,3-butadiene, acrylonitrile, methacrylic acid or hydroxyethyl methacrylate, and trimethylolpropane trimethacrylate. Further copolymerizable monomers used may be copolymerizable monomers containing carboxyl groups, for example α,β-unsaturated monocarboxylic acids, esters thereof, α,β-unsaturated dicarboxylic acids, mono- or diesters thereof or the corresponding anhydrides or amides thereof.

Also usable are additional esters of α,β-unsaturated monocarboxylic acids, preferably the alkyl esters and alkoxyalkyl esters thereof. Preference is given to the alkyl esters, particular preference is given to methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylates, butyl methacrylate and 2-ethylhexyl methacrylate. Also preferred are alkoxyalkyl esters of α,β-unsaturated monocarboxylic acids, more preferably alkoxyalkyl esters of acrylic acid or methacrylic acid, especially methoxymethyl acrylate, methoxyethyl (meth)acrylate, ethoxyethyl (meth)acrylate and methoxyethyl (meth)acrylate. Also usable are mixtures of alkyl esters, for example those mentioned above, with alkoxyalkyl esters, for example in the form of those mentioned above. Also usable are additional hydroxyalkyl acrylates and hydroxyalkyl methacrylate in which the number of carbon atoms in the hydroxyalkyl groups is 1-12, also usable are α,β-unsaturated carboxylic esters containing amino groups, such as dimethylaminomethyl acrylate and diethylaminoethyl acrylate. Suitable additional monomers having at least two olefinic double bonds per molecule selected from the group consisting of divinylbenzene, trimethylolethane tri(meth)acrylate, glycerol tri(meth)acrylate, pentaerythritol tri- and tetra(meth)acrylate, dipentaerythritol tetra-, penta- and hexa(meth)acrylate, dipentaerythritol tetra-, penta- and hexaitaconate, sorbitol tetraacrylate and sorbitol hexamethacrylate.

Preferably, the pre-crosslinked and functionalized HNBR does not comprise monomer units derived from styrene.

Preferably, the pre-crosslinked and functionalized HNBR does not comprise monomer units derived from methacrylic acid. Preferably, the polymer essentially consists of monomer units derived from 1,3-butadiene, acrylonitrile, hydroxyethyl methacrylate and trimethylolpropane trimethacrylate (tetrapolymer).

Preferably, the pre-crosslinked and functionalized HNBR does not comprise monomer units derived from hydroxyethyl methacrylate. Preferably, the polymer essentially consists of monomer units derived from 1,3-butadiene, acrylonitrile, methacrylic acid and trimethylolpropane trimethacrylate (tetrapolymer).

Preferably, the electrolyte comprises dimethyl carbonate (DMC), ethylene carbonate (EC), fluoroethylene carbonate (FEC), diethyl carbonate (DEC), propylene carbonate (PC), butylene carbonate (BC), methyl ethyl carbonate (EMC), or a mixture thereof; or a mixture of ethylene carbonate (EC) and methyl ethyl carbonate (EMC).

Preferably, the liquid phase of the pre-crosslinked and functionalized HNBR latex and/or the entire composition do(es) not comprise N-methyl-pyrrolidone (NMP).

Preferably, the liquid phase of the pre-crosslinked and functionalized HNBR latex is aqueous, means the liquid phase contains water, preferably the liquid phase contains >95% of water, most preferably >99% water.

Preferably, the cathode is a LiFePO₄ (LFP), LMFP, LCO, LMO, LMNO cathode or a NMC cathode.

Preferably, the cathode is a LifePO₄ (LFP) cathode and exhibits a capacity retention after 100 cycles of at least 95% (A), in each case determined in accordance with the experimental section.

Preferably, the cathode is homogeneous without any particles or defects (++), determined in accordance with the experimental section.

Preferably, the pre-crosslinked and functionalized HNBR has a weight content of monomer units derived from acrylonitrile within the range of from 15 wt.-% to 40 wt.-%, relative to the total weight of the polymer.

Preferably, the pre-crosslinked and functionalized HNBR has a weight content of monomer units derived from 1,3-butadiene within the range of from 55 wt.-% to 85 wt.-%, relative to the total weight of the polymer.

Preferably, the pre-crosslinked and functionalized HNBR has a weight content of monomer units derived from methacrylic acid within the range of from 1 to 5 parts by weight (phm), relative to the total weight of the polymer.

Preferably, the pre-crosslinked and functionalized HNBR has a weight content of monomer units derived from hydroxyethyl methacrylate within the range of from 2 wt.-% to 8 wt.-%, relative to the total weight of the polymer.

Preferably, the pre-crosslinked and functionalized HNBR has a weight content of monomer units derived from trimethylolpropane trimethacrylate within the range of from 0.5 wt.-% to 8 wt.-%, relative to the total weight of the polymer.

Preferably, the presence of polyvinylidene fluoride polymer (PVDF) is excluded from the scope of the claims, i.e. the amount of polyvinylidene fluoride polymer (PVDF) is 0 wt.-%.

Preferably, the pre-crosslinked and functionalized HNBR comprises or essentially consists of monomer units derived from
1,3-butadiene in an amount within the range of 55 wt.-% to 85 wt.-%, relative to the total weight of the polymer,
acrylonitrile in an amount within the range of from 15 wt.-% to 40 wt.-%, relative to the total weight of the polymer,
a functional monomer which is methacrylic acid in an amount within the range of from 1 wt.-% to 5 wt.-%, relative to the total weight of the polymer., and
a pre-crosslinking agent which is trimethylolpropane trimethacrylate in an amount within the range of from 0.5 wt.-% to 8 wt.-%, relative to the total weight of the polymer.

Preferably, the pre-crosslinked and functionalized HNBR comprises or essentially consists of monomer units derived from
1,3-butadiene in an amount within the range of from 55 wt.-% to 85 wt.-%, relative to the total weight of the polymer,
acrylonitrile in an amount within the range of from 15 wt.-% to 40 wt.-%, relative to the total weight of the polymer,
a functional monomer which is hydroxyethyl methacrylate in an amount within the range of from 2 wt.-% to 8 wt.-%, relative to the total weight of the polymer, and
a pre-crosslinking agent which is trimethylolpropane trimethacrylate in an amount within the range of from 0.5 wt.-% to 8 wt.-% relative to the total weight of the polymer.

Preferably, the pre-crosslinked and functionalized HNBR is polymer T, polymer U or polymer AC (see e.g., Table 4).

The pre-crosslinked and functionalized HNBR according to the invention is related to different aspects of the invention.

A first aspect of the invention relates to the pre-crosslinked and functionalized HNBR and its use as a binder in a cathode of a battery cell.

A second aspect of the invention relates to a cathode of a battery cell comprising the pre-crosslinked and functionalized HNBR.

A third aspect of the invention relates to a composition for manufacturing a cathode of a battery cell, said composition comprising (i) the pre-crosslinked and functionalized HNBR as part of the solid phase and (ii) a liquid phase.

A method for the manufacture of the pre-crosslinked and functionalized HNBR is not limited and the method can be according to methods known in the art. The method for the manufacture of the polymer can be any of solution polymerisation, suspension polymerisation, bulk polymerisation and emulsion polymerisation. The method for the manufacture of the polymer may be addition polymerisation, such as ionic polymerisation, radical polymerisation and living radical polymerisation.

A method for the hydrogenation is likewise not limited. The method can be any one of an oil-layer hydrogenation or a water-layer hydrogenation. A hydrogenation catalyst used in the manufacture of the hydrogenated polymer may be any hydrogenation catalyst known in the art, such as a palladium-based catalyst and a rhodium-based catalyst or any combination thereof.

When the pre-crosslinked and functionalized HNBR is used as cathode binder for a rechargeable battery, the binder holds active material and conductive material within a cathode of the rechargeable battery. The pre-crosslinked and functionalized HNBR is dispersed in a liquid phase, which is preferably aqueous to form a binder composition together with additional ingredients.

The binder composition is then preferably mixed with active material and conductive material to form a cathode slurry composition.

The active material can be a lithium nickel manganese cobalt oxide (abbreviated as Li-NMC, LNMC, NMC or NCM), which is a mixed metal oxides of lithium, nickel, manganese and cobalt. The active material can be a lithium iron phosphate (LFP). The active material can be a lithium manganese oxide (LMO). The active material can be a lithium cobalt oxide (LCO). The active material can be a lithium manganese nickel oxide (LMNO). The active material can be a Lithium manganese iron phosphate (LMFP). Lithium iron phosphate (LFP) is preferred.

The conductive material can be carbon materials such as carbon black (e.g. acetylene black, furnace black), graphite (graphene), carbon fibers (carbon nanofibers, carbon nanotubes (CNTs) and vapour-grown carbon fibers) and/or carbon flakes.

The cathode slurry composition is then preferably applied to a current collector and then dried.

The application to the current collector can be by doctor blading, dip coating, reverse roll coating, direct roll coating, gravure coating, extrusion coating, bar coater and brush coating. A thickness of the cathode slurry composition on the current collector after application but before drying may be set as appropriately.

The current collector is a material having electrical conductivity and electrochemical durability. The current collector can be made of iron, copper, aluminum, nickel, stainless steel, titanium, tantalum, gold or platinum. The current collector can be in the form of a foil. The current collector is preferably aluminum foil due to its high conductivity, electrochemical and chemical stability and low cost.

Drying of the cathode slurry composition applied to at least one surface of a current collector is preferably achieved by warm, hot, or low humidity air at ambient pressure: drying in a vacuum, drying by irradiation with infrared light or drying with electron beams can also be used.

Following drying, the cathode slurry composition applied to the current collector may be pressed, by mould pressing or roll pressing. The pressing provides a more uniform layer of the dried material.

The resultant positive cathode, comprising the polymer as positive cathode binder is then assembled to form the rechargeable battery.

The rechargeable battery is assembled, preferably by stacking the positive cathode and a negative electrode with a separator in-between, rolling or folding the resultant stack can be necessary in accordance with a shape of the rechargeable battery to place the stack in a battery vessel, filling the battery vessel with an electrolytic solution and then sealing the battery vessel.

In order to prevent pressure increase inside the rechargeable battery and occurrence of over-charging or over-discharging, an overcurrent preventing device such as a PTC device or a fuse: an expanded metal (such as a nickel sponge); or a lead plate can be provided as necessary.

The shape of the rechargeable battery may for example be a coin type, button type, sheet type, cylinder type, prismatic type or flat type.

The negative electrode may be any known negative electrode, for example carbon materials such as amorphous carbon, natural graphite, artificial graphite, natural black lead, mesocarbon microbead pitch-based carbon fiber and silicon-graphite: a conductive polymer such as polyacetylene or polyaniline: or a metal such as silicon, tin, zinc, manganese, iron, lithium (for half cells) and nickel including an alloy of the metal. The negative electrode is preferably graphite or silicon-graphite.

The separator can be a fine porous membrane or a nonwoven fabric comprising polyamide resins. The fine porous membrane can be made of a polyolefin resin (polyethylene, polypropylene, polybutene, or polyvinyl chloride). The polyolefin resin is preferred since such a separator membrane can reduce a total thickness of the separator, which increases the ratio of the active material and conductive material in the rechargeable battery and ultimately a size of the rechargeable battery.

The electrolytic solution is an electrolyte and a supporting electrolyte. The supporting electrolyte is a lithium salt, such as LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi and/or (C₂F₅SO₂)NLi. LiPF₆ is preferable as it readily dissolves in a electrolyte and exhibits a high degree of dissociation.

The electrolyte can be carbonates such as dimethyl carbonate (DMC), ethylene carbonate (EC), fluoroethylene carbonate (FEC), diethyl carbonate (DEC), propylene carbonate (PC), butylene carbonate (BC), and/or methyl ethyl carbonate (EMC); esters such as γ-butyrolactone and/or methyl formate; ethers such as 1,2-dimethoxyethane and/or tetrahydrofuran; and sulphur-containing compounds such as sulfolane and/or dimethyl sulfoxide.

Rechargable batteries based on the pre-crosslinked and functionalized HNBR according to the invention exhibit a significantly improved capacity retention compared to batteries using conventional polymer binders, which means at least 80%, preferably at least 90%, most preferred at least 95%.

To determine the capacity retention a coin cell secondary battery is charged and discharged in constant current mode (CC mode 0.2 C rate) for 100 cycles. Capacity retention is determined as the ratio of the discharge specific capacity after 100 cycles over the discharge specific capacity after the second cycle in percent. Then, the capacity retention is calculated and evaluated based on the following criteria:
A: Capacity retention is 95% or more
B: Capacity retention is 90% or more and less than 95%
C: Capacity retention is 80% or more and less than 90%
D: Capacity retention is less than 80%.

### Examples

The following examples further illustrate the invention but are not to be construed as limiting its scope.

The following materials were used as provided:
Monomer units acrylonitrile (ACN), methacrylic acid (MAA), 2-acrylamid-2-methylpropansulfonsäure (AAMPS), trimethylolpropane trimethacrylate (TMPTMA), acetoacetoxyethyl methacrylate (AAEM), hydroxyethyl methacrylate (HEMA), ethyl hexyl acrylate (EHA) from Sigma-Aldrich, 1,3-butadiene from INEOS.
Solution Fe(II)SO₄: Premix solution contains 0.986 g Fe(II)SO₄*7 H₂O and 6.0 g Rongalit® C in 400 g water.
EDTA: as complexing agent from Sigma-Aldrich.
Fatty acid: CAS 67701-08-8, emulsifier for polymerisation.
SDS: Sodium dodecyl sulfate, CAS 151-21-3, emulsifier for polymerization.
LDBS: Sodium alkyl (C10-C13) benzene sulphonate, CAS 25155-30-0, emulsifier for polymerization.
PNS: CAS 9084-06-4 Sodium poly(naphthalin formaldehyde) sulfonate, emulsifier for polymerization.
AOS: Sodium α Olefin sulfonate CAS 68439-57-6, emulsifier for polymerization
t-DDM: Molecular weight regulator from Arlanxeo Deutschland GmbH.
Glidox® 500, 2,6,6-trimethylbicyclo[3.1.1]heptylhydroperoxide from Renessenz, Initiator for emulsion polymerisation.
KPS: potassium persulfate, Initiator for emulsion polymerisation.
Diethylhydroxylamine: polymerisation terminator, CAS 3710-84-7.
Hoveyda-Grubbs, second generation, catalyst from Sigma-Aldrich as hydrogenation catalyst
Hydrogen from Nippon Gases.
SBR latex polymer for anode binder, CAS 9010-93-9, Comparative example.
Lithium iron phosphate: active material: A8-4E, from Hubei Wanrun New Energy Technology Co., LTD.
Carboxymethylcellulose (CMC): anode binder, MAC500LC, from NIPPON Paper
Conductive carbon black: conductive material, Super C65: from Imerys Graphite & Carbon.
Aluminium foil: current collector; thickness 20 μm; from China Aluminium Shanxi New Material Co.
Lithium disc: anode: ø 16 mm from China Energy Lithium Co., Ltd.
Porous polyolefin film: as separator, thickness 38 μm (Celgard 2340), punched into o 18 mm disc; from Celgard.
Electrolytic solution supporting electrolyte LiPF₆ (Aldrich). Electrolytic solution: 1M in EC/EMC mixture, EC/EMC=30/70 (v/v) with 2 wt % VC. Ethylene carbonate (EC), Ethyl methyl carbonate (EMC) and Vinylene carbonate (VC): organic solvent used for the electrolytic solution.
Battery vessel: coin cell: casing: 2032 type from ShanXi LiZhiYuan Battery Material Co.
Overcurrent preventing device: nickel sponge: thickness of 1 mm per layer, for each coin cell 4 layers were used, from Changsha LiYuan New Material Co.
3M tape: vinyl electrical tape (width of 17.5 mm) from 3M China Company.

### Test Methods

### Acrylonitrile Content:

The nitrogen content for determining the acrylonitrile content was determined in accordance with ISO 24698-1 using the Dumas method.

### NMR

The microstructure and the termonomer content of the individual polymers are determined by means of 1H NMR (instrument: Bruker AV III HD 600 NMR spectrometer with Topspin Software, measurement frequency 600 MHz, solvent CDCl₃).

### Method of Determination of Gel Content

Determination of gel content is preferably performed as follows: 250 mg of the nitrile rubber are dissolved in 25 ml of a solvent (ethyl carbonate (EC)/methyl ethyl carbonate (EMC) 3/7)) with stirring at 25° C. for 24 h. The insoluble fraction is removed by ultracentrifugation at 20 000 rpm at 25° C., dried and determined by gravimetry. Gel content is reported in % by weight based on the starting weight.

### Method of Evaluating Electrode Appearance

The evaluation of electrode appearance was subjected to visual assessment, and evaluated using the following criteria:
++ Homogeneous electrode without any particles or defects
+ Homogeneous electrode with limited amount of small undispersed particles or defects
0 Electrode is not homogeneous and showing major defects
− Electrode can only be partly prepared, and showing more voids
−− No coating possible, slurry can't be processed

### Preparation of Inventive and Comparative Polymer Latex

The components used were according to Table 1 and 2 for the manufacture of the polymer comprising monomer units among others acrylonitrile. 1,3-butadiene and functional monomers.

TABLE 1
Components used for the manufacture of polymer

| | Polymer | | | | | | | | |
|---|---|---|---|---|---|---|---|---|---|
| Ingredients (phm) | Z | Y | V | A | X | C | Q | W | G |
| Acrylonitrile | 35 | 35 | 16.5 | 35.8 | 35.8 | 35.8 | 35.8 | 20 | |
| 1,3-butadiene | 65 | 65 | 83.5 | 58.8 | 58.8 | 58.8 | 58.8 | | 47 |
| Styrene | | | | | | | | | 50 |
| Methacrylic acid | | | | 5.4 | 5.4 | | | | 3 |
| TMPTMA | | | | | | | | | |
| HEMA | | | | | | | | | |
| AAEM | | | | | | 5.4 | 5.4 | 20 | |
| EHA | | | | | | | | 59.5 | |
| AAMPS | | | | | | | | 0.5 | |
| Water | 200 | 200 | 200 | 135 | 220 | 220 | 220 | 164 | 101 |
| LDBS | | | | | | | | | 2 |
| SDS | | | 5 | 5 | 5 | 5 | 5 | 1.6 | |
| PNS | | | 2 | 1 | 1 | 1 | 1 | | 1 |
| Fatty acid | 2 | 2 | | | | | | | |
| AOS | | | | | | | | | |
| t-DDM | 0.85 | 0.85 | 0.42 | 0.55 | 0.55 | 0.55 | 0.55 | | 0.17 |
| Glidox ® 500 | 0.02 | 0.02 | 0.02 | 0.02 | 0.02 | 0.02 | 0.02 | | |
| KPS | | | | | | | | 0.3 | 0.3 |
| Solution Fe(II)SO₄ | 0.02 | 0.02 | 0.01 | 0.01 | 0.01 | 0.01 | 0.01 | | |
| Diethylhydroxylamine | 0.13 | 0.13 | 0.2 | 0.2 | 0.2 | 0.2 | 0.2 | 0.2 | |
| Polymerisation | 12 | 12 | 12 | 8 | 8 | 8 | 8 | 75 | 55 |
| temp (° C.) (±0.5) | | | | | | | | | |
| Conversion (%) | 74.2 | 74.2 | 72.2 | 84.6 | 81.3 | 82.2 | 82.2 | 99.5 | 85 |
| Hydrogenation | no | yes | yes | no | yes | no | yes | no | no |
| catalyst | | | | | | | | | |

TABLE 2
Components used for the manufacture of polymer

| | | | Polymer | | | | | | | |
|---|---|---|---|---|---|---|---|---|---|---|
| Ingredients (phm) | J | AA | O | F | T | E | U | AB | AC | L |
| Acrylonitrile | 19 | 19 | 52 | 19.2 | 19.2 | 18.5 | 18.5 | 35 | 35 | 19.2 |
| 1,3-butadiene | 77 | 77 | 41 | 74 | 74 | 72.5 | 72.5 | 56 | 56 | 74 |
| Styrene | | | | | | | | | | |
| Methacrylic acid | | | 2 | 2.8 | 2.8 | | | | | 2.8 |
| TMPTMA | 4 | 4 | | 2 | 2 | 4 | 4 | 4 | 4 | 4 |
| HEMA | | | | | | 5 | 5 | 5 | 5 | |
| AAEM | | | 5 | | | | | | | |
| EHA | | | | | | | | | | |
| AAMPS | | | | | | | | | | |
| Water | 180 | 180 | 220 | 180 | 180 | 180 | 180 | 180 | 180 | 180 |
| LDBS | | | | | | | | | | |
| SDS | 5 | 5 | 5 | 5 | 5 | 5 | 5 | 5 | 5 | 5 |
| PNS | 2 | 2 | 1 | 2 | 2 | 2 | 2 | 2 | 2 | 2 |
| Fatty acid | | | | | | | | | | |
| AOS | | | | | | | | | | |
| t-DDM | 0.2 | 0.2 | 0.55 | 0.2 | 0.2 | 0.2 | 0.2 | 0.2 | 0.2 | 0.2 |
| Glidox ® 500 | 0.02 | 0.02 | 0.02 | 0.02 | 0.02 | 0.02 | 0.02 | 0.02 | 0.02 | 0.02 |
| KPS | | | | | | | | | | |
| Solution | 0.01 | 0.01 | 0.01 | 0.01 | 0.01 | 0.01 | 0.01 | 0.01 | 0.01 | 0.03 |
| Fe(II)SO₄ | | | | | | | | | | |
| Diethylhydroxylamine | 0.2 | 0.2 | 0.2 | 0.2 | 0.2 | 0.2 | 0.2 | 0.14 | 0.14 | 0.14 |
| Polymerisation | 15 | 15 | 8 | 15 | 15 | 15 | 15 | 15 | 15 | 15 |
| temp (° C.) (±0.5) | | | | | | | | | | |
| Conversion (%) | 97.9 | 97.9 | 77.5 | 89 | 89 | 84.1 | 84.1 | 96.4 | 96.4 | 97.1 |
| Hydrogenation | no | yes | yes | no | yes | no | yes | no | yes | no |
| catalyst | | | | | | | | | | |

The respective polymer was produced batchwise in a 5 L autoclave with a stirrer system. In each of the autoclave batch, 1.25 kg of a mixture of monomers, a total amount of water of 2.1 kg was used, as was EDTA in an equimolar amount based on Fe(II) from the Fe(II)SO₄ 1.9 kg of this amount of water were initially charged with emulsifier (fatty acid and acid) in the autoclave and purged with a stream of nitrogen. The t-DDM was added, and the reactor was closed. Once the contents were brought to polymerization temperature, polymerization was initiated by the addition of the solution Fe(II)SO₄ premix solution and Glidox® 500 or KPS as sole initiator. The polymerization was running at the given temperature, if not stated otherwise, between 8-15° C. for Glidox® 500 and between 55-75° C. for KPS, and monitored by gravimetric determinations of conversion. On attainment of the conversion shown in Table 1 and 2, the polymerization was stopped by adding a 25% aqueous solution of diethyl hydroxylamine. Unconverted monomers (i.e. non-polymerized) and remaining volatiles were removed by steam distillation.

### Hydrogenation

The hydrogenation reaction was carried out in a 2 L high pressure reactor under the following conditions. First the NBR latex was concentrated to 15% solids and was charged into the reactor. The hydrogenation catalyst (0.2%/100 parts of rubber) was placed in a catalyst addition device which was installed in the head of the reactor. After assembling the reactor, the polymer latex was degassed 3 times with nitrogen (23° C., 0.5 MPa) with vigorous stirring, and the system was then heated to 120° C. Then, the catalyst was added into the NBR latex with nitrogen gas. The hydrogen pressure was set at 85 bar and reaction temperature was kept constant throughout the reaction period. The course of the reaction was monitored by measuring a residual double bond content by means of IR spectroscopy.

The reaction was terminated when the residual double bond content of <5% had been reached by releasing the hydrogen pressure. The temperature was decreased to 20° C., and the polymer latex was degassed 3 times with nitrogen (23° C., 0.5 MPa).
The properties of hydrogenated and non-hydrogenated rubber latices are shown in following Table 3 and 4.

TABLE 3
Properties of hydrogenated and non-hydrogenated acrylonitrile
butadiene rubber latices and non-inventive rubber latices

| | Comparative samples | | | | | | | | |
|---|---|---|---|---|---|---|---|---|---|
| | Z | Y | V | A | X | C | Q | W | G |
| ACN content [wt.-%] | 35 | 35 | 17 | 34 | 33 | 33 | 34 | 20 | na* |
| Crosslinker | No | No | No | No | No | No | No | No | No |
| Functional | No | No | No | Yes | Yes | Yes | Yes | Yes | Yes |
| monomer | | | | | | | | | |
| Hydrogenated | No | Yes | Yes | No | Yes | No | Yes | No | No |
| Residual double- | na* | 0.3 | 1.2 | na* | 3.6 | na* | 4.7 | na* | na* |
| bonds [%] | | | | | | | | | |
| Particle size [nm] | 78 | 80 | 61 | 68 | 81 | 71 | 77 | 83 | 172 |
| Solids [wt %] | 20 | 14 | 25 | 26 | 40 | 16 | 16 | 25 | 45 |
| Gel content [%] | nd | nd | nd | 1.7 | 57.5 | 21.8 | 5.1 | 77.8 | 100 |

na*: not applicable;
nd: not determined
Rubber latices Z, Y, V, A, X, C, Q, W and G are comparative samples.

TABLE 4
Properties of hydrogenated and non-hydrogenated
acrylonitrile butadiene rubber latices

| | | | Samples | | | | | | | |
|---|---|---|---|---|---|---|---|---|---|---|
| | J | AA | O | F | T | E | U | AB | AC | L |
| ACN content | 17 | | 42 | 19 | 19 | 19 | 19 | 32 | 32 | 19 |
| [wt.-%] | | | | | | | | | | |
| Crosslinker | Yes | Yes | No | Yes | Yes | Yes | Yes | Yes | Yes | Yes |
| Functional | No | No | Yes | Yes | Yes | Yes | Yes | Yes | Yes | Yes |
| monomer | | | | | | | | | | |
| Hydrogenated | No | Yes | No | No | Yes | No | Yes | No | Yes | No |
| Residual double- | na* | 0.3 | na* | na* | 4.7 | na* | 0.6 | na* | 0.4 | na* |
| bonds [%] | | | | | | | | | | |
| Particle size | 49 | 58 | 91 | 66 | 73 | 68 | 73 | 67 | 57 | 56 |
| [nm] | | | | | | | | | | |
| Solids [wt %] | 31 | 33 | 18 | 21 | 23 | 24 | 26 | 27 | 36 | 25 |
| Gel content [%] | nd | nd | 65.1 | nd | 99.8 | nd | 100 | nd | nd | 99.6 |

na*: not applicable;
nd: not determined
Rubber latices J, AA, O, F, L and E are comparative samples.
Rubber latices T, U and AC are inventive samples.

### Method of Electrode Preparation

Step (1)—Cathode slurry composition preparation: CMC was first dried in the oven (105° C., 2 h) and dissolved in deionized water with magnetic stirring for ˜3 hrs to obtain a homogeneous solution. Slurry was prepared by mixing Super C65 and CMC solution for 12 min×2000 rpm by using a Thinky Mixer. Afterwards, LFP was added and dispersed for 12 min×2000 rpm. Latex was added at the end and mixed for 6 min×1200 rpm. Finally, additional water was added for 6 min×1200 rpm to adjust the final solid content.

TABLE 5
Slurry formulation of LFP electrode

| Formulation | Weight ratio (%) |
|---|---|
| LFP | 93.0 |
| Super C65 | 1.4 |
| Binder | 3.7 |
| CMC | 1.9 |
| Slurry Solid Content | 50% |

Step (2)—Production of the cathode disc: The cathode slurry composition was applied with a bar coater onto a current collector (C-coated aluminum foil) using 4 mm/s coating speed to form a cathode sheet. The coater slit gap of the coating machine was adjusted to 500 μm to obtain a pre-determined coating thickness. The electrodes were dried and calendared, using 25 Mpa pressure, 120° cx 60 s with 2-roll device until dried thickness is reduced by 20% to adjust the areal density. From the calandered cathode sheet a cathode disc (o 16 mm) was punched using a machine from ShenZhen PengXiang YunDa Machinery Technology Co., Model: PX-CP-S2. The punch edge was sharp without burr.

### Method of Coin Cell Fabrication

The coin cell fabrication is carried out in a glove box. The assembly comprises the coin cell casing top (2032 type), stainless steel spacer (@16.2 mm*1.0 mm), stainless steel spring (15.4 mm*1.1 mm), the lithium disc (as anode), the porous separator (Celgard 2400), the cathode disc and the casing bottom (positive side). All parts were assembled layer-by-layer. 140 μL 1M/L LiPF₆ in EC/EMC=30/70 (v/v) with 2 wt % VC was used as electrolyte. Finally, the coin cell case was pressed by the press machine in the glovebox.

### Cycling Test

Cycling test was performed using constant current charge/discharge with 0.1 C/0.1 C for 2 cycles as the formation cycles, 0.5 C/0.5 C runs to 100 cycles in the potential range of 2.8-4.0 V vs. Li/Lit at 23° C. Specific capacity of LFP to calculate C-rate was 145 mAh/g. Capacity retention was calculated from the discharge capacity value of 100 cycles divided by the average discharge capacity on 2-5 cycles.

TABLE 6
Determination of electrode appearance of the
cathode sheet of the lithium-ion battery

| | Samples | | | | | | | | |
|---|---|---|---|---|---|---|---|---|---|
| | Z | Y | V | A | X | C | Q | W | G |
| Electrode | 0 | ++ | 0 | − | ++ | −− | 0 | + | ++ |
| appearance | | | | | | | | | |

TABLE 7
Determination of electrode appearance of the
cathode sheet of the lithium-ion battery

| | | | Samples | | | | | | | |
|---|---|---|---|---|---|---|---|---|---|---|
| | J | AA | O | F | T | E | U | AB | AC | L |
| Electrode | 0 | 0 | ++ | 0 | ++ | 0 | ++ | 0 | + | ++ |
| appearance | | | | | | | | | | |

Rubber latices J, AA, O, F, L and E are comparative samples.
Rubber latices T, U and AC are inventive samples.

Functionalized pre-crosslinked, hydrogenated nitrile rubber produced improved electrodes compared to styrene butadiene rubber or non-functionalized nitrile rubber latex. A uniform electrode is important for the battery performance of the lithium-ion battery.

TABLE 8
Determination of the discharging specific capacity and
the capacity retention of the lithium-ion battery.
Electrodes with good appearance and processing were used for
subsequent tests for the determination of the discharging specific
capacity and the capacity retention of the lithium-ion battery:

| | | Comparative samples | | | | |
|---|---|---|---|---|---|---|
| | G | W | Y | X | L | O |
| Discharging specific capacity | 125.4 | np* | 134.4 | 110.9 | 122.0 | 129.7 |
| after 100 cycles [mAh/g] | | | | | | |
| Capacity retention after | D | np* | C | C | A | D |
| 100 cycles (%) | (80.7) | | (88.4) | (84.3) | (99.8) | (49.7) |

| | Inventive samples | |
|---|---|---|
| | T | U |
| Discharging specific capacity | 128.3 | 130.2 |
| after 100 cycles [mAh/g] | | |
| Capacity retention after | A | A |
| 100 cycles (%) | (100) | (98.4) |

*Electrode is delaminating when processed in coin cell fabrication, no coin cell could be therefore prepared

The LFP electrodes prepared with functionalized pre-crosslinked, hydrogenated, nitrile rubbers performed better than those prepared with styrene butadiene, non-hydrogenated nitrile rubber or linear hydrogenated nitrile rubbers showing highest discharge specific capacity and an improved capacity retention.

1. A cathode of a battery cell comprising a pre-crosslinked and functionalized HNBR which comprises or essentially consists of monomer units derived from
1,3-butadiene,
acrylonitrile,
a functional monomer which is methacrylic acid or hydroxyethyl methacrylate, and
a pre-crosslinking agent which is trimethylolpropane trimethacrylate.

2. The cathode according to claim 1, wherein the cathode is a LifePO₄ (LFP) cathode or a NMC cathode.

3. The cathode according claim 1, wherein the cathode is a LifePO₄ (LFP) cathode and exhibits
a capacity retention after 100 cycles of at least 80% (A),
in each case determined in accordance with the experimental section.

4. The cathode according to claim 1, wherein the cathode is homogeneous without any particles or defects (++), determined in accordance with the experimental section.

5. The cathode according to claim 4, wherein the content of residual C═C double-bonds of the pre-crosslinked and functionalized HNBR is at most 5%, relative to the content of C═C double-bonds before hydrogenation.

6. The cathode according to claim 1, wherein the pre-crosslinked and functionalized HNBR has a weight content of monomer units derived from acrylonitrile
within the range of from 15 wt.-% to 25 wt.-%, relative to the total weight of the polymer; or
within the range of from 15 to 25 parts by weight (phm), based on 100 parts by weight of the monomer mixture.

7. The cathode according to claim 1, wherein the pre-crosslinked and functionalized HNBR has a weight content of monomer units derived from 1,3-butadiene within the range of from 65 to 85 parts by weight (phm), based on 100 parts by weight of the monomer mixture.

8. The cathode according to claim 1, wherein the pre-crosslinked and functionalized HNBR has a weight content of monomer units derived from methacrylic acid within the range of from 1 to 5 parts by weight (phm), based on 100 parts by weight of the monomer mixture.

9. The cathode according to claim 1, wherein the pre-crosslinked and functionalized HNBR has a weight content of monomer units derived from hydroxyethyl methacrylate within the range of from 2 to 8 parts by weight (phm), based on 100 parts by weight of the monomer mixture.

10. The cathode according to claim 1,
wherein the pre-crosslinked and functionalized HNBR does either not comprise monomer units derived from methacrylic acid or does not comprise monomer units derived from hydroxyethyl methacrylate; and/or
which does not involve or comprise any polyvinylidene fluoride polymer (PVDF).

11-13. (canceled)
